(19) United States
(12) Patent Application Publication
(10) Pub. No.: US 2005/0053836 A1
(43) Pub. Date: Mar. 10, 2005

(54) Gas storage media, containers, and battery employing the media

(76) Inventors: Ronald James Kelley, Coral Springs, FL (US); Steven Duane Pratt, Ft. Lauderdale, FL (US); Sivakumar Muthuswamy, Plantation, FL (US); Robert W. Pennisi, Boca Raton, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/945,498

(22) Filed: Sep. 20, 2004

Related U.S. Application Data
(62) Division of application No. 10/298,084, filed on Nov. 15, 2002.

(51) Int. Cl. H01M 4/58; H01M 4/62

(52) U.S. Cl. 429/218.2; 429/217

(57) ABSTRACT

An improved hydrogen storage medium in the form of a fabric (124, 504, 704) comprises a yarn (300, 400) that includes carbon nanofibers or carbon nanotubes (302, 404) and elastomeric fibers (304, 402). The fabric (124, 504, 704) is a volume efficient arrangement of the carbon nanofibers or carbon nanotubes (302, 404) and is consequently characterized as a high density energy storage medium. According to a preferred embodiment a hydrogen storage device (100) comprises a flexible container (104) that includes the fabric (124). The flexibility of the container (104) in combination with the flexibility of the fabric (124) allows the hydrogen storage device 100 to be accommodated in irregularly shaped spaces. According to an embodiment of the invention a battery (700) uses the fabric (704) as a hydrogen storing anode.

### CROSS REFERENCE TO RELATED APPLICATIONS

This application is a divisional of pending U.S. application Ser. No. 10/298,084, filed Nov. 15, 2002, and assigned to Motorola, Inc.

### BACKGROUND OF THE INVENTION

1. Field of the Invention

The present invention relates in general to high density storage of gases. The present invention is applicable to high density storage of hydrogen for fuel cell applications.

2. Description of Related Art

Recently there has been increased attention to renewable energy sources. With this, has come an increased interest in fuel cells. Hydrogen fuel cells in particular have been identified as a very promising technology. Hydrogen fuel cells convert chemical energy yielded by the reaction of hydrogen with an oxidant into electric power.

In as much as oxygen is readily available in the atmosphere, the only reactant that must be stored for use in terrestrial based hydrogen type fuel cells is hydrogen. A figure of merit that is applicable to any energy storage technology is the achievable energy density associated with the energy storage technology. Energy density can be measured in terms of energy stored per unit volume and energy stored per unit mass. It is desirable that both figures be high.

In so far as hydrogen is a gas at standard temperature and pressure, it can be stored in a compressed state in a high pressure gas cylinder. However, the required wall thickness required for a gas cylinder for storing a given pressure of hydrogen is such that hydrogen filled gas cylinders are characterized by a relatively low energy density (either in terms of mass or volume).

One approach to increasing the energy storage density of hydrogen storage containers that has been tried is to store hydrogen within a container that is filled with a metal hydride forming material. Unfortunately, after repeated charging and discharging, metal hydride forming materials tend to disintegrate into a powder that is relatively impermeable to hydrogen, and consequently the storage capacity of such containers dramatically decreases with use.

More recently, it has been proposed to use carbon nanofibers and carbon nanotubes as a hydrogen storage medium. Carbon nanofibers, and carbon nanotubes have been reported to be able to hold high densities of hydrogen. It is believed that hydrogen stored in such structures resides in carbon lattice interstices, or within the nanotubes empty cores.

Although discrete carbon nanotubes, and carbon nanofibers are highly ordered on an atomic scale, as grown carbon nanotubes and nanofibers, are not regularly arranged. Rather, they are somewhat randomly arranged in position and orientation. Moreover, over their lengths, carbon nanotubes and carbon nanofibers tend to curl around in a random manner. The disordered arrangement tends to decrease the volumetric density of the nanotubes and nanofibers, leaving a large amount of unutilized space. A small volumetric density tends to decrease the volumetric density with which hydrogen can be stored in a mass of carbon nanotubes or nanofibers, and correspondingly a decrease in the energy density associated with hydrogen stored in the carbon nanotubes or nanofibers.

### BRIEF DESCRIPTION OF THE FIGURES

The present invention will be described by way of exemplary embodiments, but not limitations, illustrated in the accompanying drawings in which like references denote similar elements, and in which:

FIG. 1 is a first partial cutaway perspective view of a hydrogen storage device according to the preferred embodiment of the invention;

FIG. 2 is a second partial cutaway perspective view of the hydrogen storage device shown in FIG. 1;

FIG. 3 is a sectional perspective view of a twisted blended yarn that is used in the hydrogen storage devices shown in FIGS. 1,2,7,8 and the battery shown in FIG. 10 according to the preferred embodiment of the invention;

FIG. 4 is a sectional perspective view of a core spun yarn that is used in the hydrogen storage devices shown in FIGS. 1,2,7,8 and the battery shown in FIG. 10 according to a first alternative embodiment of the invention;

FIG. 5 is a sectional perspective view of a filament 500 that is used in the hydrogen storage devices shown in FIGS. 1,2,7,8 and the battery shown in FIG. 10 according to a second alternative embodiment of the invention.

FIG. 6 is a sectional perspective view of a filament 600 that is used in the hydrogen storage devices shown in FIGS. 1,2,7,8 and the battery shown in FIG. 10 according to a third alternative embodiment of the invention.

FIG. 7 is a partial cutaway perspective view of a hydrogen storage device according to a fourth alternative embodiment of the invention;

FIG. 8 is a partial cutaway perspective view of a hydrogen storage device according to a fifth alternative embodiment of the invention;

FIG. 9 is a perspective view of a hydrogen storage medium 900 that is used in the hydrogen storage devices shown in FIGS. 1,2,7,8 and the battery shown in FIG. 10 according to a sixth embodiment of the invention;

FIG. 10 is a cross sectional view of a hydride battery according to a seventh alternative embodiment of the invention; and

FIG. 11 is a flow chart of a method of manufacturing a fabric that is used in the hydrogen storage devices shown in FIGS. 1,2,7,8 and the battery shown in FIG. 10 according to the preferred embodiment of the invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term hydrogen as used in the present specification includes all the isotopes of hydrogen.

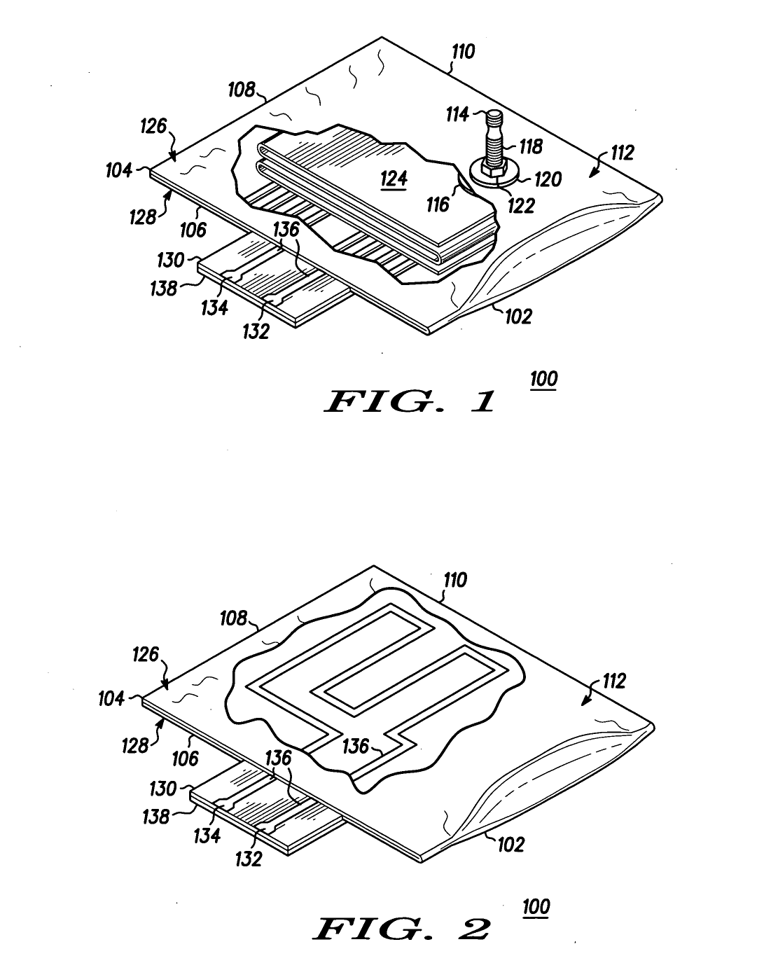

FIG. 1 is a first partial cutaway perspective view of a hydrogen storage device 100 according to the preferred embodiment of the invention. The hydrogen storage device 100 comprises a container 102 that is made out of a mylar sheet 104. The mylar sheet 104 comprises an upper half 126 and lower half 128. The mylar sheet 104 is folded in half and sealed along three edges 106, 108, 110 where the sheet 104 comes together when folded. The three edges 106, 108, 110 can be sealed by an adhesive, by application of heat, pressure, or ultrasonic energy, or a combination of the foregoing. Alternatively, the container 102 is made from two separate sheets that are sealed together along their peripheral edges.

An outside surface 112 of the mylar sheet 104 is preferably aluminized. Aluminizing the outside surface 112 serves to decrease the permeability of the container 102 to hydrogen.

A gas coupling nipple 114 is mounted through a hole (not shown) in the mylar sheet 104. The gas coupling nipple 114 comprises a flange 116, and a threaded shaft 118. The flange 116 is located inside the container 102. A rubber sealing grommet (not shown) is located between the flange 116 and the mylar sheet 104. A nut 122, is threaded onto the threaded shaft 118, and presses a washer 120 against the mylar sheet 104. The mylar sheet 104 is clamped between the grommet on the flange 116 and the washer 120 by the nut 122. Alternatively, the gas coupling nipple 114 is attached to the container 102 by bonding (e.g., ultrasonic) or other means. The gas coupling nipple 114 can for example comprise a Schraeder valve.

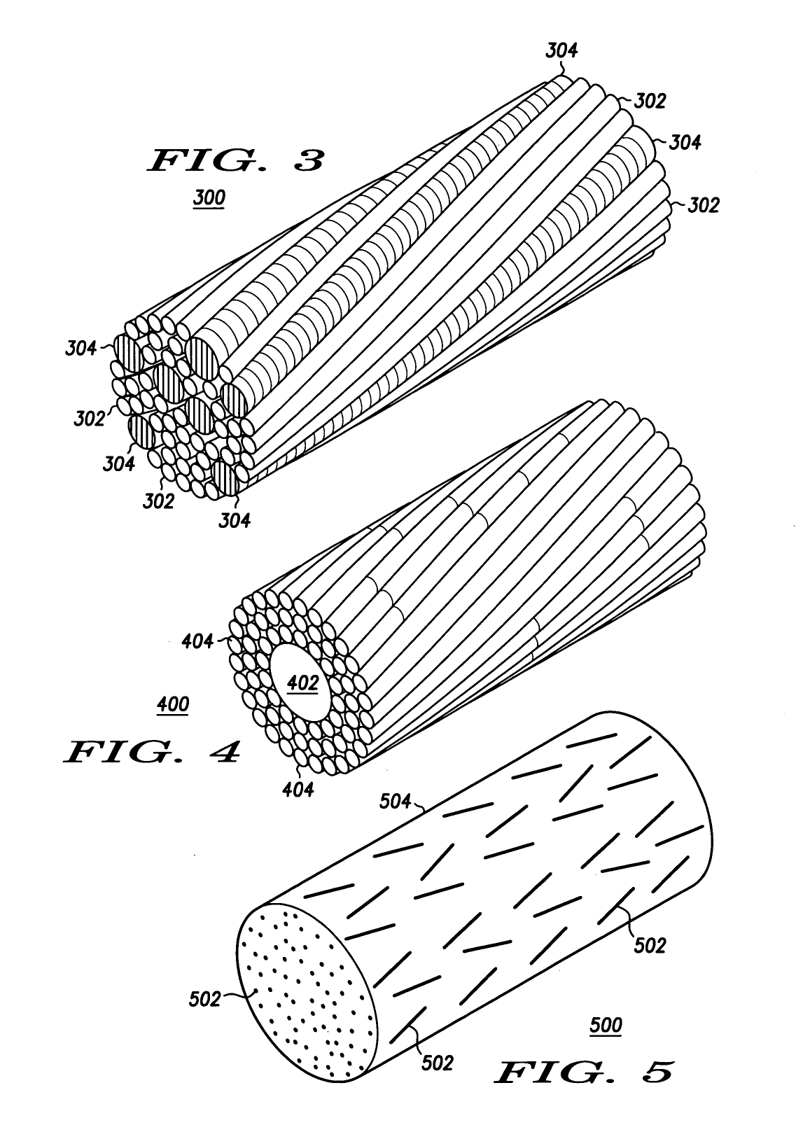

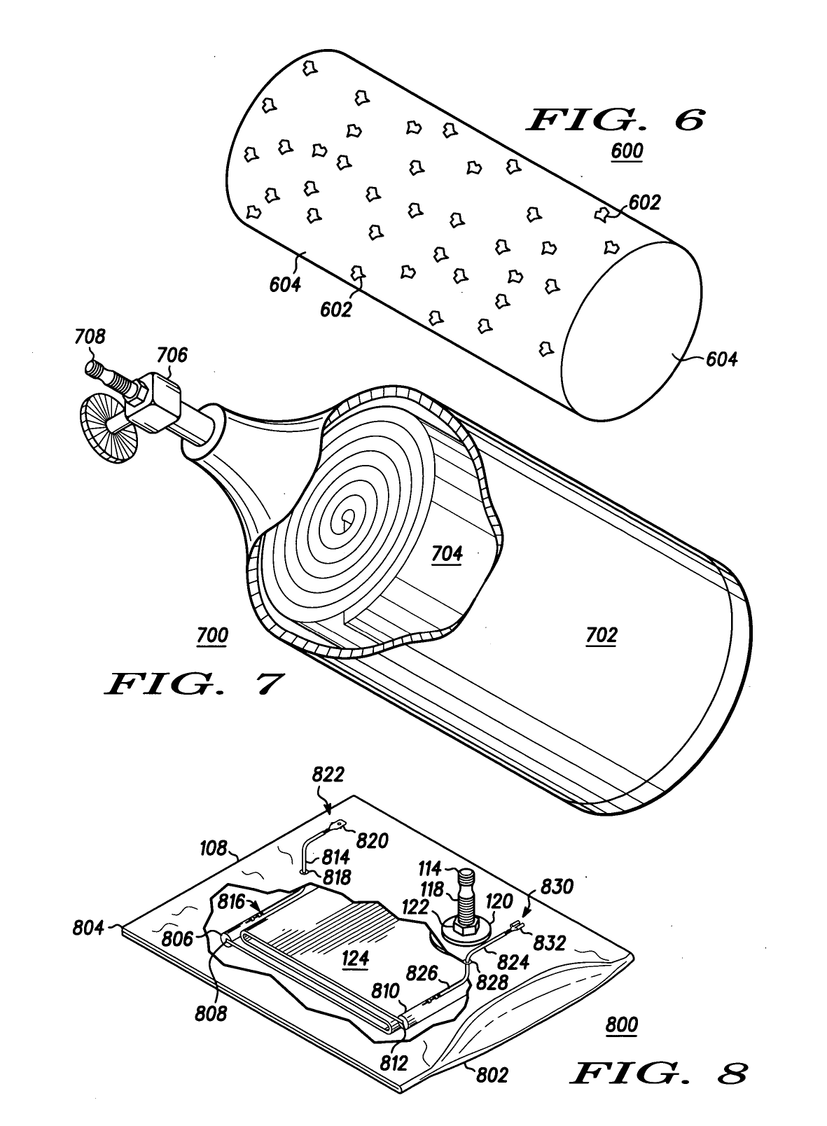

A hydrogen storage medium in the form of a folded fabric 124 is enclosed within the container 102. The fabric 124 comprises carbon nanotubes or carbon nanofibers. Preferably, the fabric 124 comprises a yarn 300 (FIG. 3), 400 (FIG. 4) that includes carbon nanotubes and/or carbon nanofibers. By organizing carbon nanofibers and/or carbon nanotubes in a fabric, the carbon nanofibers and/or carbon nanotubes are arranged in a relatively volume efficient manner. That is to say, a high density of carbon nanotubes or carbon nanofibers is provided. Both woven and knitted fabrics provide a particularly high density arrangement for carbon nanofibers or carbon nanotubes, and consequently provide a high (energy/volume) density energy storage medium. Alternatively, the fabric comprises a filament 500 (FIG. 5), 600 (FIG. 6) that includes a hydrogen absorbing material, in a matrix of flexible polymeric material.

By utilizing a flexible mylar container 102, allowance is made for expansion and contraction of the fabric 124 which occurs during charging the fabric 124 with hydrogen, and discharging hydrogen from the fabric 124. Additionally, in as much as the mylar container 102 is flexible, the flexibility of the fabric 124 allows the hydrogen storage device 100 as a whole to be flexible and to conform to irregular spaces within energy consuming devices within which it is desired to located the hydrogen storage device 100. For example, in portable electronic devices, in the interest of maximizing space utilization, it may be desirable to provide an irregularly shaped space for an energy storage device. In the latter case the hydrogen storage device 100 due to its flexibility can conform to and more fully utilize the provided irregular space. The inherent flatness of the fabric 124 also allows the hydrogen storage device 100 to be dimensioned to fit within very narrow spaces.

The lower half 128 of the mylar sheet 104 includes a tab portion 130, that extends peripherally beyond the upper half 126. A first terminal portion 132, and a second terminal portion 134 of a conductive trace 136 are located on the extending tab portion 130 of the mylar sheet 104. The conductive trace 136 serves as an ohmic heating element for heating the fabric 124. Heating the fabric 124 after it has been charged with hydrogen induces the carbon nanotubes or carbon nanofibers in the fabric to release the hydrogen.

A support backing board 138 is bonded to the tab portion 130. The board 138 facilitates connecting the terminal portions 132, 134 on the tab portion 130 to an electrical connector (not shown) that is used to supply electric current to the conductive trace 136.

FIG. 2 is a second partial cutaway perspective view of the hydrogen storage device 100 shown in FIG. 1. In the depiction in FIG. 2, the fabric 124 and the gas coupling nipple 114 are absent, so that the run of the conductive trace 136 within the container 102 can be seen. The conductive trace 136 is preferably covered by an electrically insulating, thermally conductive film or material, for example a coating (not shown).

FIG. 3 is a sectional perspective view of a twisted blended yarn 300 that is used in the hydrogen storage 100 devices shown in FIGS. 1,2,7,8 and the battery shown in FIG. 10 according to the preferred embodiment of the invention. The fabric 124 is preferably woven or knitted from the blended yarn 300. Alternatively, the fabric 124 includes other types of yarns as well. Referring to FIG. 3, the blended yarn comprises a first constituent 302 that is selected from the group consisting of carbon nanofibers and carbon nanotubes, and a second constituent of elastomeric fibers 304. The elastomeric fibers 304 preferably comprise spandex.

The presence of the elastomeric fibers 304 enhances the ability of the blended yarn 300 to accommodate expansion and contraction of the carbon nanofibers and/or carbon nanotubes 302 that occurs when hydrogen is taken up and released by the carbon nanofibers and/or carbon nanotubes 302 and reduces the undesirable internal stresses that might otherwise develop within the blended yarn 302.

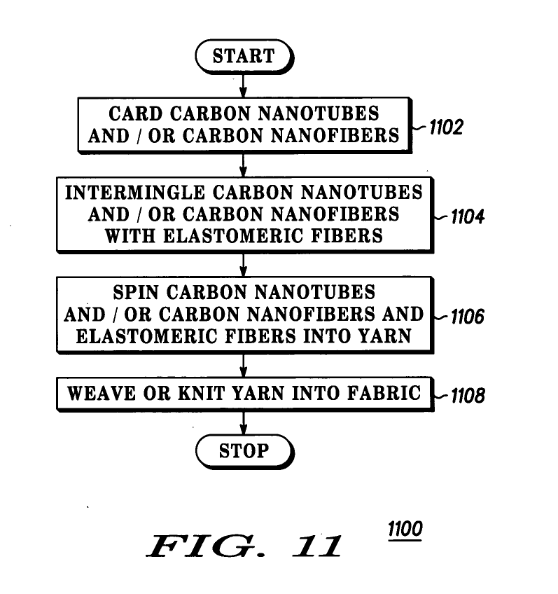

The blended yarn 300 is manufactured by a process 1100 (FIG. 11) that comprises the step of carding nanofibers and/or nanotubes in order to substantially align then. In order to blend the nanofibers and/or nanotubes 302 with the elastomer fibers 304, the nanofibers or nanotubes 302 are preferably carded together with the elastomer fibers 304. A pair of cards that has a surface structure that is scaled proportionally to the dimensions of the nanofibers or nanotubes 302 can be used for low volume production. Microlithography is suitable for making cards with surface structure appropriately scaled for carding the nanofibers and/or nanotubes 302. For higher volume production a motorized rotating drum type carding machine is preferred. Again, in the latter case, surface structure of the carding machine is scaled in proportion to the dimension of the materials 302, 304 to be carded. After carding, the blended carded nanotubes or nanofibers 302, and elastomer fibers 304 are spun to form the yarn 300, and thereafter the yarn 300 is woven to form the fabric 124.

FIG. 4 is a sectional perspective view of a core spun yarn 400 that is used in the hydrogen storage devices shown in FIGS. 1-2, 7,8 and the battery shown in FIG. 10 according to a first alternative embodiment of the invention. The core spun yarn 400 comprises an core that comprises one or more (one as illustrated) elastomeric fibers 402 surrounded by fibers 404 selected from the group consisting of carbon nanofibers and carbon nanotubes. The core spun yarn is advantageous in that carbon nanofibers and/or carbon nanotubes 402 situated toward the outside of the core spun yarn 400 and thus in better position to release or take up hydrogen.

According to alternative embodiments of the invention the blended yarn 300, and the core spun yarn 400 include an organic binder such as silicone, polytetrafluoroethylene, or propylene. The organic binder can be applied by passing the blended yarn 300, or the core spun yarn 400 through a coating cup that is filled with a solution of the binder to be applied.

According to another alternative embodiment of the invention elastomeric fibers are not included in the fabric 124.

FIG. 5 is a sectional perspective view of a filament 500 that is used in the hydrogen storage devices shown in FIGS. 1,2,7,8 and the battery shown in FIG. 10 according to a second alternative embodiment of the invention. The filament of the second alternative embodiment 500 includes carbon nanofibers and/or carbon nanontubes 502 embedded in a polymeric matrix 504. The polymeric matrix 504 preferably comprises a highly hydrogen permeable polymer. In particular, the polymeric matrix 504 preferably comprises silicone. Silicone has the added advantage that it is compliant and thus suitable for making a flexible fabric hydrogen storage medium. Compliance also allows the matrix 504 to accommodate dimensional changes of the carbon nanofibers and/or nanotubes that occur when hydrogen is taken up and released. The filament 500 is suitably formed by dry spinning or wet spinning using a suspension of carbon nanofibers and/or carbon nanotubes in a solution of the polymer of which the matrix is to be made. In dry spinning or wet spinning the filament 500, is preferably drawn to reduce its diameter.

Alternatively, the filament 500 is produced by electrospinning from a mass of polymer in which the carbon nanofibers and/or carbon nanotubes 502 are dispersed. Such a mass of polymer can be prepared by melting a polymer, adding the carbon nanofibers and/or carbon nanotubes 502, mixing the resulting mixture, and subsequently allowing it to solidify.

FIG. 6 is a sectional perspective view of a filament 600 that is used in the hydrogen storage devices shown in FIGS. 1,2,7,8 and the battery shown in FIG. 10 according to a third alternative embodiment of the invention. The filament 600 of the second alternative embodiment 600 includes metal hydride particles and/or metal hydride forming metal particles 602 in a polymeric matrix 604. Examples of metal hydrides that are suitable for use as particles 602 include Lanthanum-Pentanickel Hydride, Vanadium Hydride, Magnesium-Nickel Hydride, and Iron-Titanium Hydride.

The third alternative embodiment filament 600 is preferably formed by electrospinning from a mass of hydrogen permeable polymer (which forms the matrix 604) in which the particles 602 are dispersed.

The fabrics 124, 704 (FIG. 7), 1004 (FIG. 10) alternatively comprises the filaments shown in FIGS. 5 and 6.

FIG. 7 is a partial cutaway perspective view of a hydrogen storage device 700 according to a fourth alternative embodiment of the invention. The fourth alternative hydrogen storage device 700 comprises a gas cylinder 702 inside of which is located a roll of a fabric 704. The fabric 704 preferably comprises a yarn that includes carbon nanofibers and/or carbon nanotubes, e.g., blended yarn 300, and/or core spun yarn 400. Owing to the hydrogen uptake capacity of carbon nanotubes and carbon nanofibers, the hydrogen storage capacity of the cylinder 702 is increased by the inclusion of the roll of fabric 704. The fabric 704 provides a stable mechanical configuration for supporting the carbon nanotubes and/or carbon nanofibers that are included in the fabric 704. Thus unlike a cylinder filled with a metal hydride forming material which degrades with continued use, the fourth alternative hydrogen storage device can be reused without substantial degradation. The gas cylinder 702 further comprises a valve 706 and a threaded coupling fitting 708 for coupling the gas cylinder to an external system (not shown).

FIG. 8 is a partial cutaway perspective view of a hydrogen storage device 800 according to a fifth alternative embodiment of the invention. The fifth alternative hydrogen storage device 800 also comprises a container 802 in the form of a fold sheet of aluminum coated mylar 804. The fabric 124 is enclosed within the container 802. A first elongated electrical contact 806 is crimped on a first edge 808 of the fabric 124. Similarly, a second elongated electrical contact 810 is crimped on a second edge 812 of the fabric 124 that is opposite the first edge 808. A first electrical lead 814 has a first end 816 crimped into the first elongated electric contact 806. The first electric lead passes out of the container 802 through a first feedthrough 818 that passes through the mylar 804. A first terminal 820 is crimped onto a second end 822 of the first lead 814. Similarly a second lead 824 has a first end 826 that is crimped into the second elongated electrical contact 810, passes through a second feedthrough 828 and includes a second end 830 onto which a second terminal 832 is crimped. Alternatively, both leads 814, 824 are brought out to a single connector. The electrical leads 814, 824 and elongated electrical contacts 806, 810 are used to pass a current through the fabric 124, and to thereby heat the fabric 124 in order to induce carbon nanofibers, or carbon nanotubes within the fabric 124 to release hydrogen. The foregoing arrangement for heating the fabric 124 exploits inherent conductivity (albeit with a finite resistance) of carbon nanofibers and carbon nanotubes in the fabric 124.

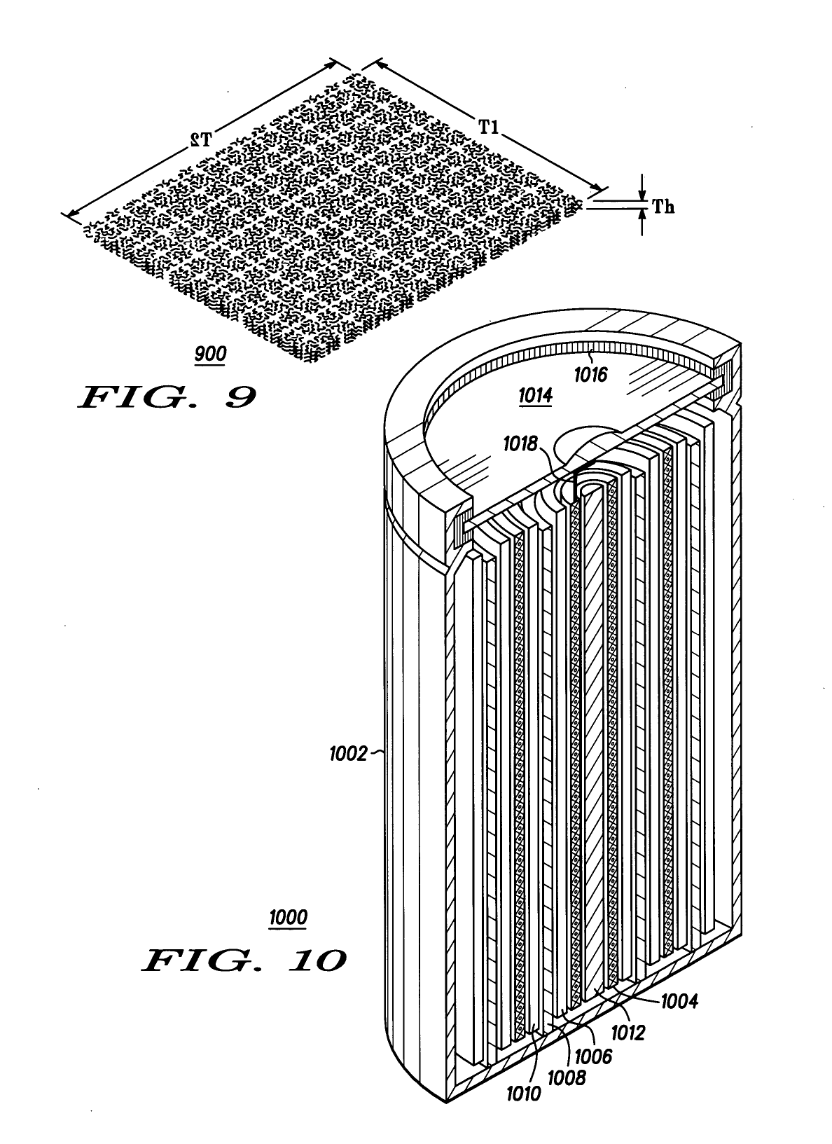

FIG. 9 is a perspective view of a hydrogen storage medium 900 that is used in the hydrogen storage devices shown in FIGS. 1,2,7,8 and the battery shown in FIG. 10 according to a sixth embodiment of the invention. The hydrogen storage medium of the sixth alternative embodiment 900 comprises a mass of entangled carbon nanofibers and/or carbon nanofibers that have been compressed into a relatively flat structure i.e. a felt of carbon nanofibers and/or nanotubes. The thickness dimension Th is substantially smaller that the transverse dimensions T1, T2. The carbon nanofiber and/or carbon nanotube felt 900 can be folded or rolled up, and used in the hydrogen storage devices shown in FIGS. 1, 2, 7, 8 and the battery shown in FIG. 10 in lieu of the fabrics 124, 704, 1004.

FIG. 10 is a cross sectional view of a battery 1000 according to a seventh alternative embodiment of the invention. The battery 1000 comprises a cylindrical case 1002 that encloses a plurality of layers 1004, 1006, 1008, 1010 wrapped around a core 1012. The plurality of layers include a fabric 1004 that is preferably made from the blended yarn 300 shown in FIG. 3. Alternatively, the fabric 1004 comprises the core spun yarn 400 shown in FIG. 4, the filament 500 shown in FIG. 5, and/or the filament 600 shown in FIG. 6. The fabric 1004 serves as an anode of the battery 1000. In the latter capacity, the fabric 1004 temporarily stores hydrogen that is released in the course of discharging the battery 1000. Thus, the fabric 1004 serves in place of metal hydride anodes that are used in conventional metal hydride batteries. The plurality of layers further include, a first separator layer 1006, a cathode foil 1008, and a second separator layer 1010. The first 1006, and second 1010 separate layers are electrolyte layers that electrochemically coupled the cathode foil 1008, and the fabric 1004. The cathode foil 1008 preferably comprises nickel.

An anode cap 1014 closes the cylindrical case 1002. The anode cap 1014 is insulated from the cylindrical case 1002 by an insulating sealing ring 1016. An anode contact 1018 connects the anode cap 1002 to the fabric 1004. The cathode foil 1008 is electrically connected to the case 1002.

In charging the battery 1000 an electrical potential is applied between the case 1002 and the anode cap 1018 so as to bias the fabric 1004 negatively with respect to the foil 1008. Under such bias, the water is decomposed into hydrogen, and a hydroxyl ion. The hydrogen produced is absorbed in the fabric 1004, and the hydroxyl ion oxidizes nickel hydroxide at the cathode foil 1008 forming nickel oxyhydroxide. In discharging the battery 1000, the hydrogen stored in the fabric 1004 gives up an electron and reacts with a hydroxyl ion form water. At the cathode foil a free electrons received from the anode cap 1004 via the case 1002 reduces nickel oxyhydroxide again forming nickel hydroxide. Analogous reactions occur if a cathode foils 1008 that includes materials other than nickel are used.

FIG. 11 is a flow chart of a method 1100 of manufacturing the fabrics 124 704 1004 used in hydrogen storage devices shown in FIGS. 1,2,7,8 and the battery shown in FIG. 10 according to the preferred embodiment of the invention. In step 1102 carbon nanotubes and/or carbon nanofibers are carded in order to arrange them more parallel to each other. In step 1104 the carbon nanotubes and/or carbon nanofibers are intermingled with elastomeric fibers. The order of the preceding two steps 1102,1104 is alternatively interchanged. In step 1106 the carbon nanotubes and/or carbon nanofibers and the elastomeric fibers are spun into a yarn. The blended twisted yarn 300 illustrated in FIG. 3, or the core spun yarn 400 illustrated in FIG. 4 can be produced in step 1106. In step 1108 the yarn obtained in the preceding step 1106 is woven or knitted into the fabric.

According to an alternative embodiment of the invention carbon nanofibers and/or carbon nanotubes are first carded and spun to produce carbon nanofiber and/or carbon nanotube threads which are then spun with elastomeric fibers to form yarns.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

1. A hydride battery comprising:
a cathode;
an anode for storing and discharging hydrogen, the anode including:
a fabric including a hydrogen absorbing material; and
an electrolyte electrochemically linking the anode and the cathode.

2. The hydride battery according to claim 1 wherein:
the fabric comprises:
a yarn including one or more materials selected from the group consisting of carbon nanotubes and carbon nanofibers.

3. The hydride battery according to claim 1 wherein:
the fabric comprises a filament including a hydrogen absorbing material embedded in a hydrogen permeable polymeric matrix.

4. The hydride battery according to claim 3 wherein the hydrogen absorbing material includes a material selected from the group consisting of carbon nanofibers and carbon nanotubes.

5. The hydride battery according to claim 3 wherein the hydrogen absorbing material includes a material selected from the group consisting of metal hydride forming metals and metal hydrides
